(19) United States
(12) Patent Application Publication
(10) Pub. No.: US 2005/0167258 A1
(43) Pub. Date: Aug. 4, 2005

(54) Movable contact unit

(76) Inventors: Yoshiro Sano, Tsuyama-shi (JP); Masahiro Ito, Katsuta-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/039,935

(22) Filed: Jan. 24, 2005

(30) Foreign Application Priority Data
Feb. 2, 2004 (JP) 2004-25220
Feb. 2, 2004 (JP) 2004-25221

(51) Int. Cl. H01H 1/10

(52) U.S. Cl. 200/512

(57) ABSTRACT

A movable contact unit includes a first movable contact stuck on an adhesive layer beneath a lower face of an insulating film, and a second movable contact placed on the insulating film such that it is overlaid on the first movable contact via the insulating film in between. The movable contact unit has greater repulsive force and is excellent in durability.

### FIELD OF THE INVENTION

The present invention relates to a movable contact unit of a switch to be used in an operating panel of a variety of electronic devices.

### BACKGROUND OF THE INVENTION

A movable contact unit formed by bonding a movable contact shaped like a dome onto flexible insulating film is widely used in a switch of an operating panel of various electronic devices. FIG. 14 shows a sectional view of a conventional movable contact unit. The unit shown in FIG. 14 is enlarged in a thickness direction in order to show the structure more understandably. Adhesive layer 2 is prepared beneath flexible insulating film 1, and plural movable contacts 3 shaped like a dome and made of conductive thin metal plate are bonded onto adhesive layer 2, so that plural movable contact units 30 are formed.

A placement of the plural movable contact units is determined depending on each one of the switches of an operating panel. FIG. 15 shows a perspective exploded view of a movable contact unit to be used in a cellular phone. Plural movable contacts 3 or 4 forming plural movable contact units are placed as illustrated.

FIG. 16 shows a sectional view illustrating a conventional switch of an operating panel. A movable contact unit having movable contacts 3 is bonded onto circuit board 7 having fixed contact 6 (contacts 6A, 6B) via adhesive layer 2. A center section of movable contact 3 opposes to fixed contact 6A via a space, and a circumference of movable contact 3 is brought into contact with fixed contact 6B. A pair of movable contact 3 and fixed contact 6 forms an individual switch of the operating panel. Operating button 8 movable up and down is provided on each one of the movable contact unit.

When depressing force applied to button 8 exceeds repulsive force of domed movable contact 3, contact 3 bows downward moderately as shown in FIG. 17, then the center section of contact 3 comes into contact with fixed contact 6A, so that fixed contacts 6A and 6B on circuit board 7 are electrically connected to each other via movable contact 3. Removing the depressing force applied to button 8 prompts resilient restoring force of contact 3 to restore button 8 and contact 3 to the original position shown in FIG. 16, so that the electrical connection between fixed contacts 6A and 6B on board 7 is disconnected.

In the movable contact units used in a cellular phone and shown in FIG. 15, the unit having movable contact 4 placed at the center of contacts 5 placed crosswise is used for an “enter” operation. Japanese Patent Application Non-Examined Publication No. 2002-216582 discloses that movable contact 4 has repulsive force greater than movable contacts 3 around contact 4 to prevent a careless “enter” operation. In this case, it is difficult for movable contact 4 to obtain satisfactory durability while contact 4 gets greater repulsive force than movable contacts 3 and maintains the same dimensions as contacts 3.

### SUMMARY OF THE INVENTION

The present invention addresses the problem discussed above, and aims to provide a movable contact unit having greater repulsive force as well as superb durability.

The movable contact unit of the present invention comprises the following elements:
an insulating film having an adhesive layer at its lower face;
a first movable and domed contact bonded to the adhesive layer, the contact ready to repel a depression applied thereon; and
a second domed movable contact placed on an upper face of the insulating film concentrically with the first movable contact, the second contact ready to repel a depression applied thereon.

The movable contact unit of the present invention has great repulsive force summed of the repulsive force of first and second movable contacts. Each one of the first and second movable contacts has superb durability, so that the movable contact unit of the present invention is also equipped with superb durability.

### BRIEF DESCRIPTION OF THE DRAWINGS

FIG. 1 shows a sectional view of a movable contact unit in accordance with a first exemplary embodiment of the present invention.

FIG. 2 shows a perspective exploded view of the movable contact unit in accordance with the first exemplary embodiment of the present invention.

FIG. 3 shows a sectional view illustrating switches, equipped with the movable contact unit shown in FIG. 1, of an operating panel.

FIG. 4 shows a sectional view of a movable contact unit in accordance with a second exemplary embodiment of the present invention.

FIG. 5 shows a ring-shaped adhesive layer.

FIG. 6 shows a sectional view of switches, equipped with the movable contact unit shown in FIG. 4, of an operating panel.

FIG. 7A shows a step of manufacturing the movable contact unit shown in FIG. 4.

FIG. 7B shows a step of manufacturing the movable contact unit shown in FIG. 4.

FIG. 8 shows a step of manufacturing the movable contact unit shown in FIG. 4.

FIG. 9 shows a step of manufacturing the movable contact unit shown in FIG. 4.

FIG. 10 shows a step of manufacturing the movable contact unit shown in FIG. 4.

FIG. 11 shows a step of manufacturing the movable contact unit shown in FIG. 4.

FIG. 12 shows a step of manufacturing the movable contact unit shown in FIG. 4.

FIG. 13 shows a step of manufacturing the movable contact unit shown in FIG. 4.

FIG. 14 shows a sectional view illustrating a conventional movable contact unit.

FIG. 15 shows a perspective exploded view of the conventional movable contact unit.

FIG. 16 shows a sectional view of switches, equipped with the movable contact unit shown in FIG. 14, of an operating panel.

FIG. 17 shows a sectional view illustrating a switch, bowing downwardly or turning inside out, of an operational panel.

### DETAILED DESCRIPTION OF PREFERRED EMBODIMENT

### Exemplary Embodiment 1

The first exemplary embodiment of the present invention is demonstrated hereinafter with reference to accompanying drawings. Similar elements to those described in the background of the invention have the same reference marks, and the detailed descriptions thereof are omitted here.

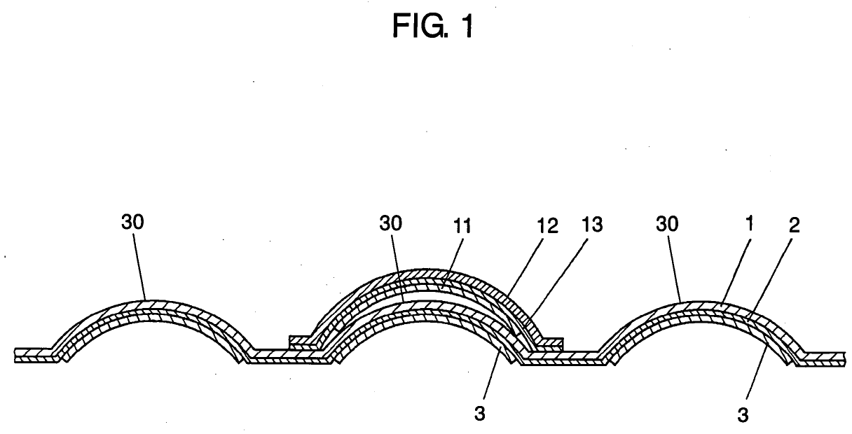

FIG. 1 shows a sectional view of a movable contact unit in accordance with the first exemplary embodiment of the present invention. Adhesive layer 2 is prepared beneath flexible insulating film 1, and plural movable contacts 3 shaped like a dome and made of conductive thin metal plate are bonded onto adhesive layer 2, so that plural movable contact units 30 are formed.

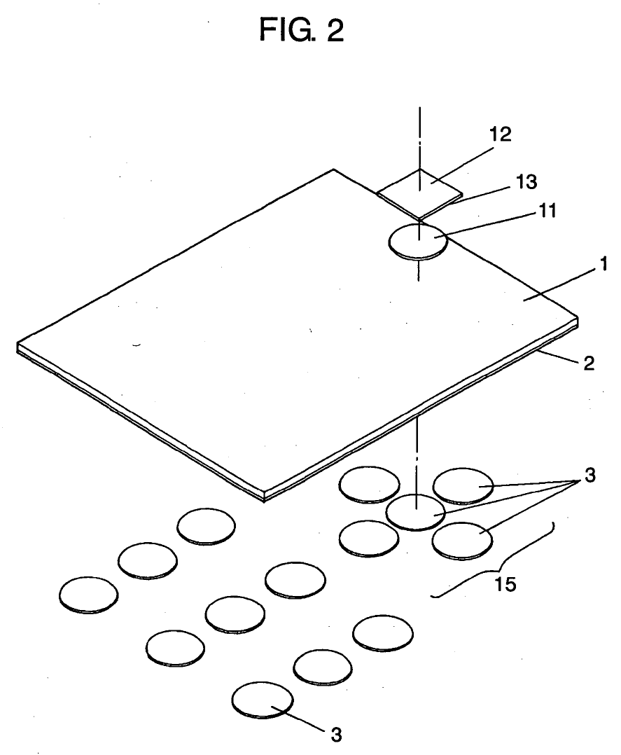

As an example, the following case is demonstrated, where those movable contact units are used in a cellular phone. FIG. 2 shows a perspective exploded view of the movable contact units used in a cellular phone. The movable contact unit (the contact unit at the center in FIG. 1) having movable contact 3 placed at the center of cross shape 15 is used for an “enter” operation. This movable contact unit is comprises the following elements:
movable contact 11 placed on movable contact 3 concentrically via insulating film 1; and
fixing film 12 having adhesive layer 13 for sticking contact 11 onto insulating film 1.
   Movable contact 11 is the same one as movable contact 3.

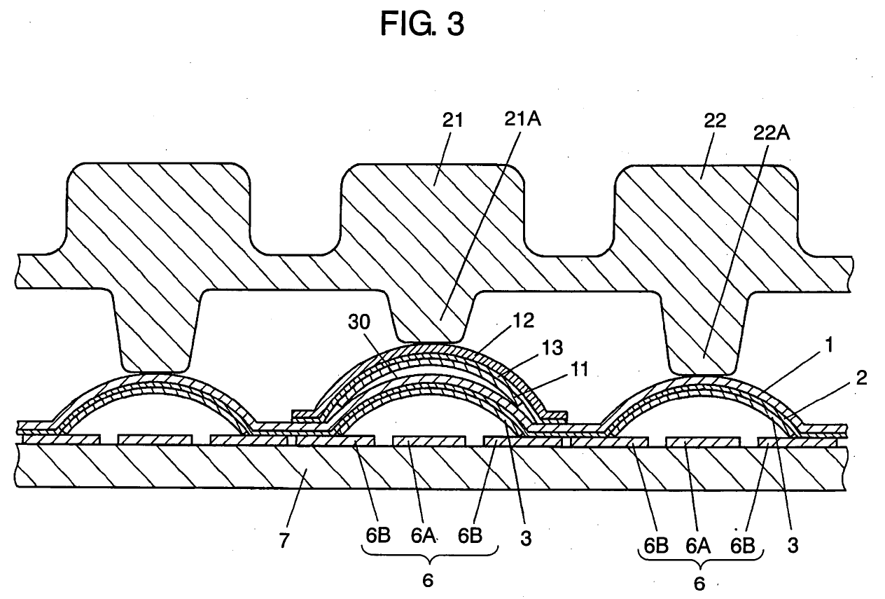

FIG. 3 shows a sectional view illustrating a switch of an operating panel. Movable contact unit 30 is bonded on circuit board 7 having fixed contact 6 (6A, 6B) via adhesive layer 2. A pair of movable contact 3 and fixed contact 6 forms an individual switch of the operating panel. This is the same as the conventional one.

Operating buttons 21, 22 movable up and down are placed respectively on each one of the movable contact units, so that the switch of an operating panel is constructed. Button 21 corresponds to the movable contact unit, i.e. the movable contact unit of the present invention, including movable contacts 3 and 11, and button 22 corresponds to a regular movable contact unit including only movable contact 3.

Next, an operation of the foregoing switch of the operating panel is demonstrated hereinafter. Since a regular movable contact unit operates upon depressing button 22 in a similar way to the conventional one, the description thereof is omitted here. An operation of the movable contact unit of the present invention upon depressing button 21 is described here.

When depressing force applied to operating button 21 exceeds approx. twice as much as repulsive force of movable contact 3, namely, the sum of repulsive force of movable contacts 11 and 3, both of movable contacts 11 and 3 bow downward at the same time, so that the center section of movable contact 3 comes into contact with fixed contact 6A in a similar way to the conventional one. As a result, fixed contacts 6A and 6B are electrically connected to each other via movable contact 3. Removal of the depressing force applied to button 21 prompts elastic restoring force of movable contacts 11 and 3 to restore movable contacts 11, 3 and button 21 to their original statuses, so that fixed contact 6A is electrically discontinued from fixed contact 6B.

As discussed above, the movable contact unit of the present invention formed by overlaying movable contact 11 on movable contact 3 can produce repulsive force approx. twice as much as the regular movable contact unit formed of only movable contact 3. Since movable contacts 11 and 3 are the same, the movable contact unit of the present invention has durability similar to that of the regular movable contact unit.

Transparent or semi-transparent insulating film is desirably used as both of insulating film 1 and fixing film 12 because both of the movable contacts can be seen in the assembling line, so that they can be assembled concentrically with ease. Insulating film made of polyethylene-terephthalate fits both of insulating film 1 and fixing film 12. A thickness of the film falling within 12.5-25 μm gives fixing film 12 better operating tactile impression.

### Exemplary Embodiment 2

The second exemplary embodiment of the present invention is demonstrated hereinafter with reference to accompanying drawings. Similar elements to those described in the background of the invention have the same reference marks, and the detailed descriptions thereof are omitted here.

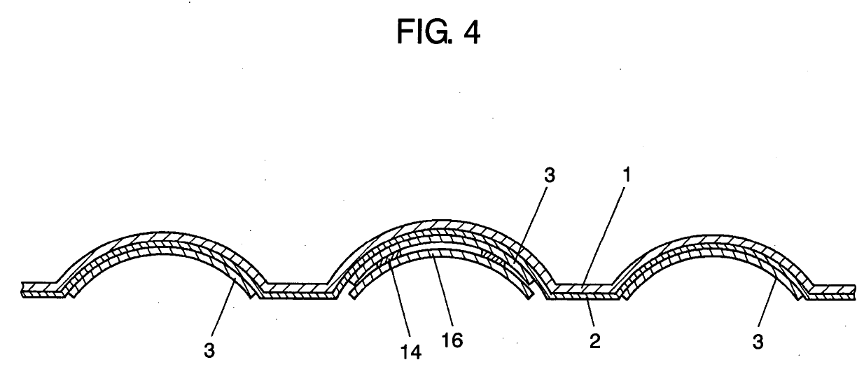

FIG. 4 shows a sectional view of a movable contact unit in accordance with the second exemplary embodiment of the present invention. Adhesive layer 2 is prepared beneath flexible insulating film 1, and plural movable contacts 3 shaped like a dome and made of conductive thin metal plate are bonded onto adhesive layer 2, so that plural movable contact units are formed.

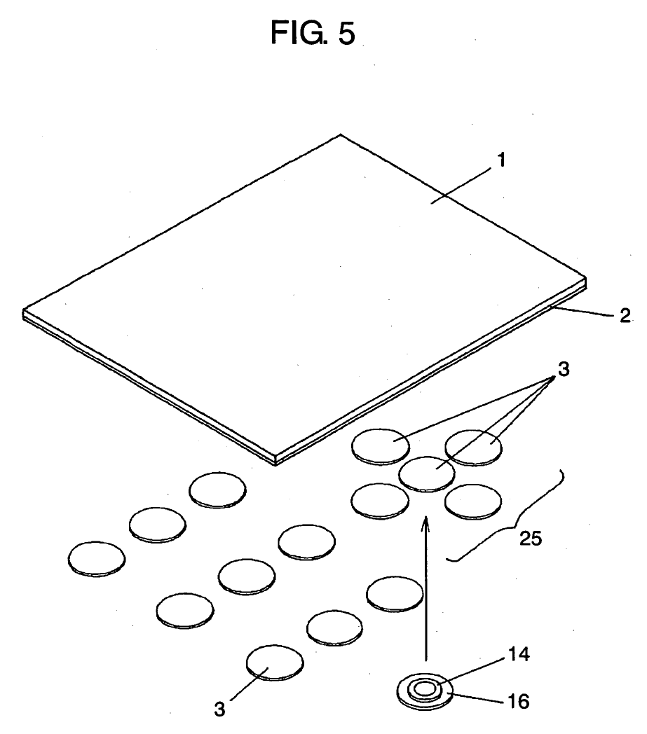

As discussed in the first embodiment, repulsive force of the movable contact unit (the center movable contact unit) for the “enter” operation is desirably greater. To achieve this desire, movable contact 16 shown in FIG. 5 is bonded to the lower face of movable contact 3 concentrically via ring-shaped adhesive layer 13. As a result, the repulsive force of the movable contact unit for the “enter” operation becomes approx. twice as much as that of movable contact 3, namely, the sum of repulsive force of movable contacts 16 and 3.

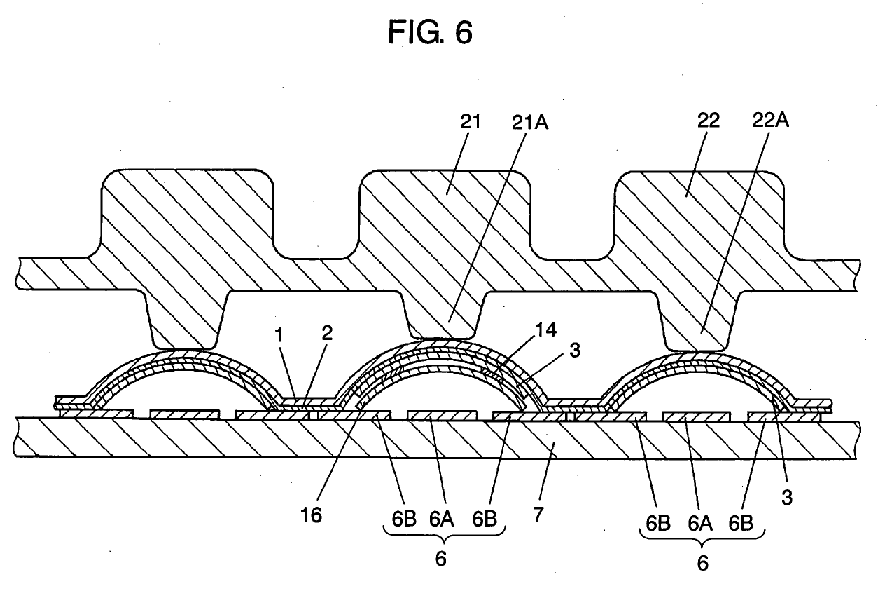

FIG. 6 shows a sectional view of switches of an operating panel. The construction and operation of the switches are similar to those demonstrated in the first embodiment (cf. FIG. 3), and the description thereof is thus omitted here.

Adhesive layer 14 preferably employs acrylic adhesive excellent in weather resistance because of an outdoor use. Adhesive layer 14 shaped like a ring is formed on movable contact 16, so that no adhesive layer 14 is available at the center section because large deformation occurs at the center section during the operation. An accident such as peel-off of the adhesive layer at the center section does not happen, so that the switches can operate in a stable manner over a long period.

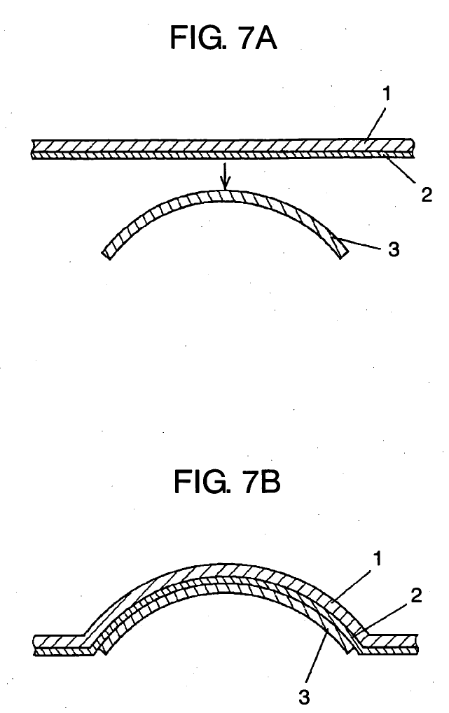

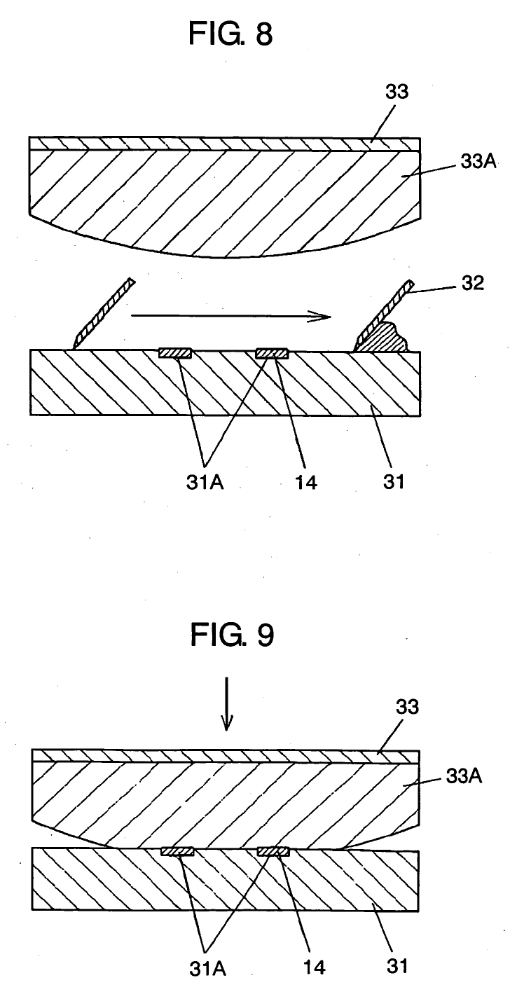

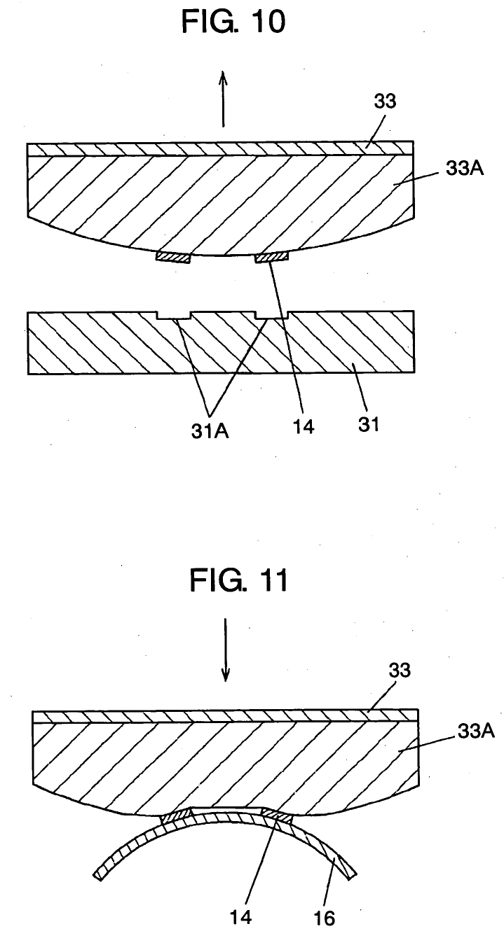

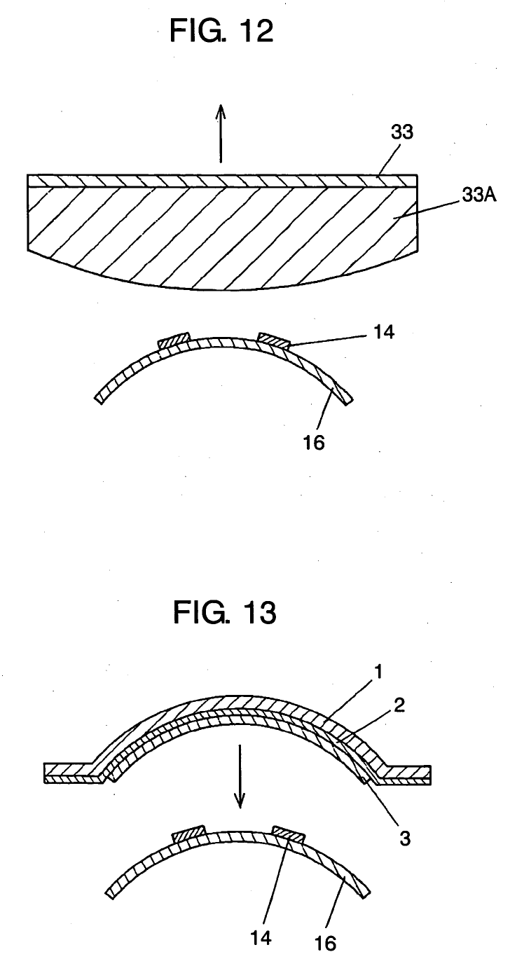

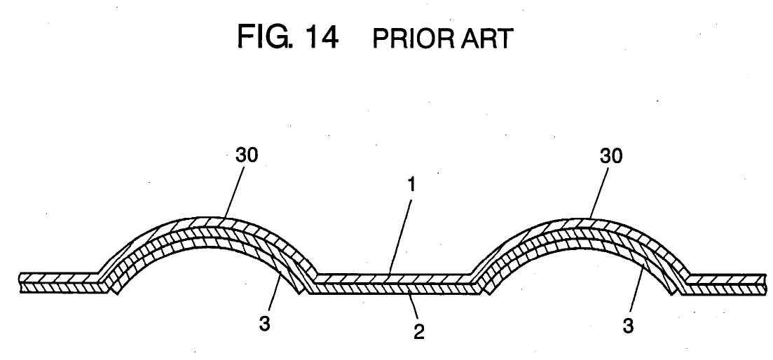

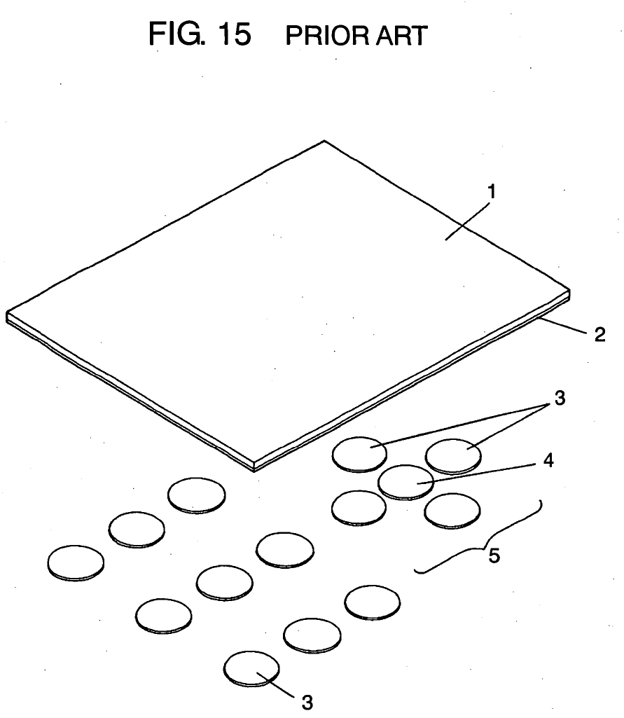

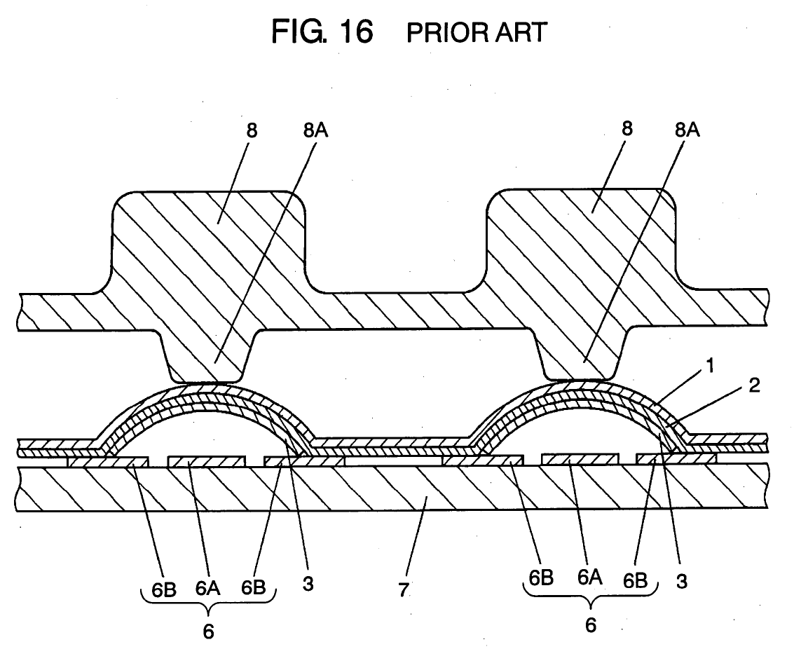

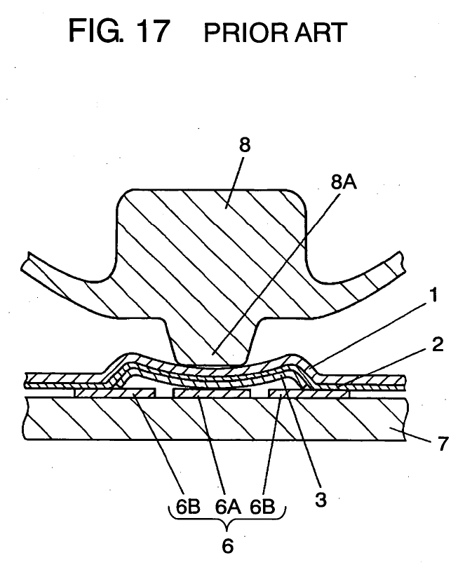

A method of manufacturing the movable contact shown in FIG. 4 is demonstrated hereinafter. The manufacturing method includes the following steps:
(a) bonding domed movable contact 3 onto adhesive layer 2 disposed on a lower face of flexible insulating film 1 as shown in FIG. 7A and FIG. 7B;
(b) filling ring-shaped recess 31a of die 31 with acrylic-based adhesive 14 by squeegee 32 as shown in FIG. 8, and placing pad 33A made of silicone rubber above die 31;
(c) urging pad 33A against die 31 as shown in FIG. 9, then lifting pad 33A, so that adhesive 14 in recess 31A is transcribed onto pad 33A as shown in FIG. 10;
(d) urging pad 33A against movable contact 16 as shown in FIG. 11, then lifting pad 33A, so that adhesive 14 is transcribed onto movable contact 16 as shown in FIG. 12, thereby obtaining movable contact 16 having ring-shaped adhesive layer 14 at its upper face; and
(e) bonding movable contact 3 and movable contact 16 together concentrically via ring-shaped adhesive layer 14 in between as shown in FIG. 13. As a result, the movable contact unit of the present invention is obtained.

1. A movable contact unit comprising:
a first insulating film having a first adhesive layer underneath a lower face of the film;
a first movable contact shaped like a dome and bonded onto the first adhesive layer and bowing downward upon being depressed; and
a second movable contact shaped like a dome and disposed on an upper face of the first insulating film concentrically with the first movable contact and bowing downward upon being depressed.

2. The movable contact unit of claim 1 further comprising a second insulating film having a second adhesive layer beneath a lower face of the second insulating film, wherein the second movable contact is boned on the lower face of the second insulating film via the second adhesive layer, and the second insulating film is bonded on the upper face of the first insulating film via the second adhesive layer.

3. The movable contact unit of claim 1, wherein the first insulating film is one of transparent and semi-transparent.

4. The movable contact unit of claim 1, wherein the second insulating film has a thickness ranging from not thinner than 12.5 μm and not thicker than 25 μm.

5. A movable contact unit comprising:
a first insulating film having a first adhesive layer underneath a lower face of the film;
a first movable contact shaped like a dome and bonded onto the first adhesive layer and bowing downward being depressed; and
a second movable contact shaped like a dome and disposed on an lower face of the first movable contact concentrically and bowing downward upon being depressed.

6. The movable contact unit of claim 5, wherein the first movable contact and the second movable contact are bonded together with an adhesive layer made of acrylic-based adhesive.

7. The movable contact unit of claim 5, wherein the first movable contact and the second movable contact are bonded together with an adhesive layer shaped like a ring.

8. A method of manufacturing a movable contact unit that comprises:
a first insulating film having a first adhesive layer underneath a lower face of the film;
a first movable contact shaped like a dome and bonded onto the first adhesive layer and bowing downward upon being depressed; and
a second movable contact shaped like a dome and disposed on an lower face of the first movable contact concentrically and bowing downward upon being depressed,
wherein the first movable contact and the second movable contact are bonded together with an adhesive layer shaped like a ring,
the method of manufacturing the movable contact unit comprising the steps of:
(a) transcribing a ring-shaped adhesive layer onto an upper face of the second movable contact concentrically; and
(b) bonding the second movable contact having the adhesive layer concentrically to the lower face of the first movable contact by using the adhesive layer.
